(19) United States
(12) Patent Application Publication
(10) Pub. No.: US 2010/0104226 A1
(43) Pub. Date: Apr. 29, 2010

(54) Electrical machine with rotor bearing

(76) Inventors: Steffen Katzenberger, Bad Liebenzell (DE); Joachim Heizmann, Immendingen (DE)

Correspondence Address: Striker, Striker & Stenby, 103 East Neck Road, Huntington, NY, 11743, US

(21) Appl. No.: 12/580,584

(22) Filed: Oct. 16, 2009

(30) Foreign Application Priority Data
Oct. 23, 2008 (DE) 102008043128.1

(51) Int. Cl. F16C 23/08

(52) U.S. Cl. 384/210

(57) ABSTRACT

A motor, in particular an electrical machine, has a housing, a rotor, and a rotor bearing which includes at least two bearing parts which are rotatable relative to one another, one of which is assigned to the rotor, and the other of which is assigned to the housing. The rotor bearing is designed as a sintered part, and that the bearing part assigned to the housing includes a rotation lock, and/or that the bearing part assigned to the rotor includes a rotation lock.

### CROSS-REFERENCE TO RELATED APPLICATION

The invention described and claimed hereinbelow is also described in DE 10 2008 043 128.1 filed on Oct. 23, 2008. This German Patent Application, whose subject matter is incorporated here by reference, provides the basis for a claim of priority of invention under 35 U.S.C. 119(a)-(d).

### BACKGROUND OF THE INVENTION

The present invention relates to an electrical machine, in particular a motor, comprising a housing, a rotor, and a rotor bearing that includes at least two bearing parts which are rotatable relative to one another, one of which is assigned to the rotor, and the other of which is assigned to the housing.

Electrical machines comprising a housing and a rotor supported therein in a rotatable manner currently include ball bearings to support the rotor, in particular in “open frame” applications, in which the motor and its stationary parts (stator, electrical connections, etc.) are formed directly with the housing, and without the presence of a motor intermediate housing. These ball bearings are used to rotatably support the rotor in a manner having the least amount of play and the greatest amount of operational reliability possible, in order to ensure that the motor operates without interruption and with an uninhibited generation of force. Ball bearings are used because other bearings, due to their material properties, are unable to provide an adequately reliable fastening capability in the housing. However, the ball bearings used today are relatively expensive.

### SUMMARY OF THE INVENTION

The object of the present invention is to provide an electrical machine, in particular a motor, that includes a rotor bearing that avoids the disadvantages stated above, and that makes it possible to design the rotor bearing in a particularly cost-favorable manner.

To this end, an electrical machine, in particular a motor, is provided, which includes a housing, a rotor, and a rotor bearing that includes at least two bearing parts which are rotatable relative to one another, one of which is assigned to the rotor, and the other of which is assigned to the housing. These bearing parts form a rotor bearing. It is provided that the rotor bearing is designed as a sintered part, and that the bearing part assigned to the housing includes a rotation lock, and/or that the bearing part assigned to the rotor includes a rotation lock.

The bearing part that is assigned to the housing, i.e., that is accommodated and held by the housing, and in which the bearing part assigned to the rotor is rotatably supported, therefore includes a rotation lock that prevents specifically this bearing part from rotating relative to the housing. Optionally, in addition or as an alternative thereto, the bearing part that is assigned to the rotor, and that therefore provides rotatable support in the bearing part assigned to the housing, is also provided with a rotation lock, i.e., a rotation lock opposite the rotor. As a result, it is also ensured that the bearing part assigned to the rotor does not rotate relative to the rotor. In the case of a simple design of the bearing parts that is common in the related art, a rotation lock of this type is not adequate when these bearing parts are designed as sintered bearings.

Due to the material properties of the sintered material, e.g., sintered bronze, adequate attachment to the housing or the rotor is not ensured, with the unfortunate result that components may become detached and, in very unfavorable cases, that bearing parts may also begin to rotate in housing parts assigned to them or on the rotor itself. Via the proposed embodiment which includes at least one rotation lock, it is ensured that the corresponding bearing part is unable to rotate relative to the housing or the rotor on which it should be non-rotatably formed. Rotation of the bearing parts therefore takes place only on bearing surfaces provided for this purpose, namely relative to one another.

In one embodiment of the present invention, the rotor bearing is designed as a sintered friction bearing. Sintered friction bearings are bearings in which sintered bearing surfaces glide on top of one another without the use of further sliding elements such as bearings or rollers between them. Due to the material properties of the sintered material, it is possible to attain very high levels of accuracy, in particular rotational accuracies. The porous sintered structure may be filled with lubricants, thereby ensuring that a large supply of lubricant is always available. This embodiment is much less expensive than ball bearings that are composed of several individual parts, i.e., bearing shells and sliding elements, and on which lubricant may be lost.

In one embodiment, the rotation lock is designed as a mechanical rotation lock. A mechanical rotation lock is one that, due to its mechanical structure, prevents an undesired relative rotation by counteracting a torque.

In a preferred embodiment, the rotation lock is designed as a non-rotationally symmetric design of the bearing part. A non-rotationally symmetric design of the bearing part is one, e.g., in which a flattening of the bearing part exists, along with an appropriate, corresponding geometry of the housing part or rotor part that accommodates the bearing part, or it is a structure that extends beyond the rotationally symmetrical design, e.g., a lever-type or peg-shaped extension on at least one point past the rotational symmetry of the bearing part; this extension is situated in an appropriate recess in the housing component that accommodates the bearing part.

In a further embodiment, it is provided that the rotation lock is designed as a (circumferential, in particular) notch structure or a segment structure. In this design, notches or segments are formed around the circumference of the bearing part (on the outside or the inside, depending on the application); a design of this type extends around the circumference in particular and in more or less short intervals. As a result, a holding force may very effectively be generated, in particular when the bearing part is enclosed by the retaining housing part, since relatively large working surfaces that act transversely to the torque are available. Particularly preferably, bearing parts may also be cast in plastic housings in this manner, where they are captively held in a non-rotatable manner.

Particularly preferably, motors that are supported in this manner are manufactured as open-frame motors, i.e., as motors that are installed in a plastic housing, e.g., of an electric hand-held power tool driven by a rechargeable battery, without a dedicated motor housing. The motor is therefore formed in the plastic housing of the electric hand-held power tool, and is not used as a separate component with a separate housing in this manner, electric hand-held power tools may be manufactured in a particularly economical manner. Using the rotor bearing described above, it is ensured that the stability and loading capacity are adequate for the particular output requirements and application.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a top view of a rotor bearing that includes a mechanical rotation lock,

FIG. 2 shows a rotor bearing of this type with a non-rotationally symmetrical design of the rotation lock, and

FIG. 3 shows a rotor bearing of this type with a non-rotationally symmetrical design of both bearing parts.

### DESCRIPTION OF THE PREFERRED EMBODIMENTS

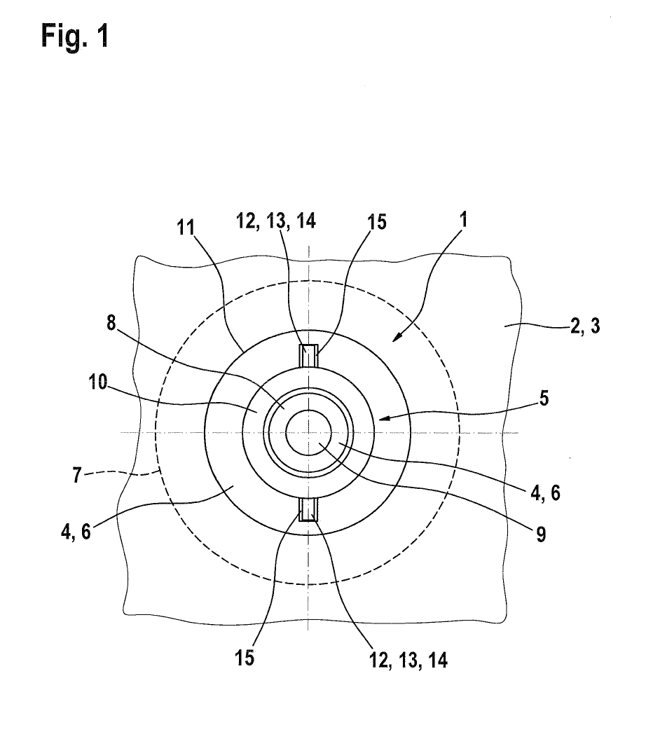

FIG. 1 shows rotor bearing 1 in a top view, in a housing 2—only a section of which is shown—of an electrical machine 3.

For this purpose, rotor bearing 1 includes bearing parts 4 which, together, form a rotor bearing 5. Bearing parts 4 are sintered friction bearings 6, and include a bearing part 8 that is assigned to schematically depicted rotor 7 of electrical machine 3 and that is installed on a rotor shaft 9 of rotor 7, and a bearing part 10 that encloses bearing part 8, is assigned to housing 2, and is retained in housing 2, in particular in a housing part 11 having a shape similar to that of bearing part 10 assigned to the housing. On bearing part 10 assigned to housing 2, a rotation lock 12 designed as projections 13 which are diametrically opposed and are situated on the outer circumference of bearing part 10 assigned to the housing is formed as mechanical rotation lock 14.

Projections 13 are situated in recesses 15 in a form-fit manner; recesses 15 are formed in housing part 11 to receive projections 13. As a result, when rotor shaft 9 and bearing part 8 assigned to rotor 7 rotate inside bearing part 10 assigned to housing 2, bearing part 10 assigned to housing 2 is prevented from accidentally rotating as well, and bearing part 10 is prevented from rotating relative to housing 2 and/or housing part 11. Between bearing part 8 assigned to rotor 7 and bearing part 10 assigned to housing 2, bearing takes place via bearing surfaces formed on the outer circumference of bearing part 8 assigned to rotor 7, and on bearing surfaces formed on the inner circumference of bearing part 10 assigned to the housing.

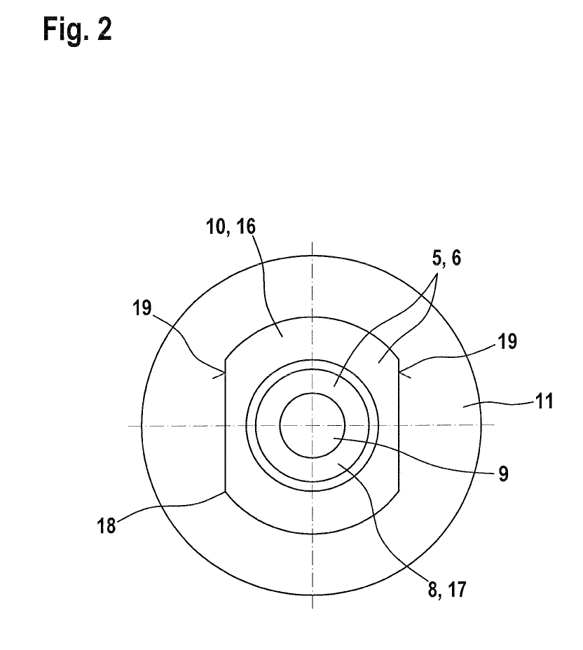

FIG. 2 shows a rotor bearing 5 designed as a sintered friction bearing 6 that includes a bearing part 8 assigned to housing 2, as the outer bearing part 16, and a bearing part 8 assigned to rotor 7 or rotor shaft 9, as inner bearing part 17. Outer bearing part 16 has a non-rotationally symmetrical design 18, i.e., that includes flattened sides 19 that are diametrically opposed to one another, thereby resulting in rotation lock 12. The non-rotationally symmetrical design of outer bearing part 16 is retained in housing part 11 in a form-fit manner, so that, when rotor shaft 9 and associated inner bearing part 17 rotate, outer bearing part 16 does not accidentally rotate as well, and thereby preventing outer bearing part 16 from rotating relative to housing part 11.

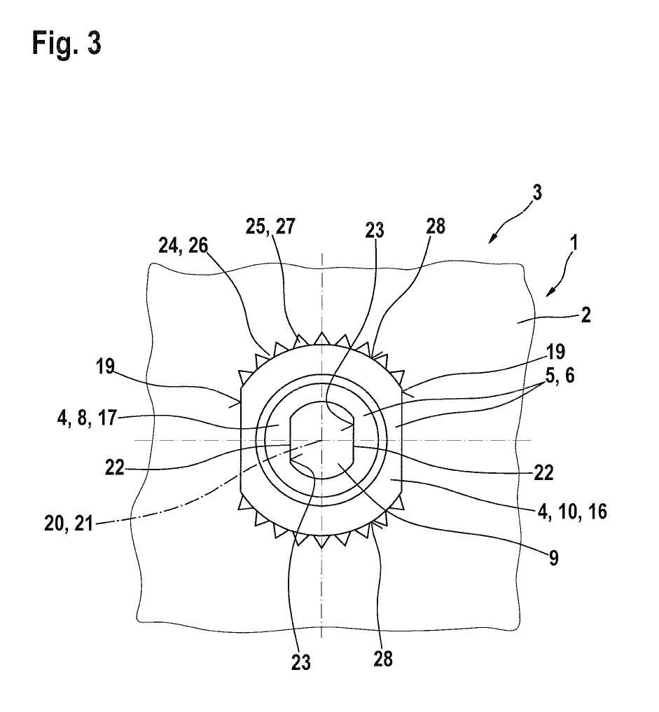

FIG. 3 shows a rotor bearing 1 of an electrical machine 3 (only a section of which is shown) with housing 2; rotor bearing 5 is formed of outer bearing part 16 and inner bearing part 17, and both bearing parts 4 together form one sintered friction bearing 6. Inner bearing part 17 is bearing part 8 assigned to rotor 7, and outer bearing part 16 is bearing part 10 assigned to housing 2. Both bearing parts 4 are non-rotationally symmetrical in design. Inner bearing part 17 includes flattened inner bearing part sides 22 on the inner circumference, around the entire circle, that point in the direction of a rotational axis 20 as the bearing center 21; inner bearing part sides 22 correspond to flattened sections 23 on rotor shaft 9 in a form-fit manner.

Rotation lock 12 designed in this manner therefore prevents inner bearing part 17 from rotating on rotor shaft 9 relative to rotor shaft 9. Outer bearing part 16 includes flattened sides 19, as described above with reference to FIG. 2, and corresponds to a related form-fit in housing 2. In addition, outer bearing part 16 has a notch structure 24 and a segment structure 25; notches 26 and segments 27 extend on circumferentially extending outer bearing jacket outer surfaces 28 substantially parallel to rotation axis 20 of rotor shaft 9 in an alternating manner and in essentially equal intervals. Notch structure 24 and segment structure 25 correspond to related structures in housing 2, e.g., housing 2 is cast around notch structure 24 or segment structure 25, thereby resulting in an intimate, form-fit connection. Rotation lock 12 designed in this manner therefore prevents outer bearing part 16 from rotating relative to housing 2.

It will be understood that each of the elements described above, or two or more together, may also find a useful application in other types of constructions differing from the types described above.

While the invention has been illustrated and described as embodied in an electrical machine with a rotor bearing, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An electrical machine, comprising a housing; a rotor; a rotor bearing including at least two bearing parts which are rotatable relative to one another, with one of said bearing parts assigned to said rotor, and the other of said bearing parts assigned to said housing, wherein said rotor bearing is configured as a sintered part, and wherein at least one of said bearing parts includes a rotation lock.

2. The electrical machine as defined in claim 1, wherein one of said bearing parts of said rotor bearing includes said rotation lock.

3. The electrical machine as defined in claim 1, wherein said one bearing part of said rotor bearing which is assigned to said housing includes a rotation lock.

4. The electrical machine as defined in claim 1, wherein one of said bearing parts of said rotor bearing which is assigned to said rotor includes a rotation lock.

5. The electrical machine as defined in claim 1, wherein said rotor bearing is configured as a sintered friction bearing.

6. The electrical machine as defined in claim 1, wherein said rotation lock is configured as a mechanical rotation lock.

7. The electrical machine as defined in claim 1, wherein said rotation lock is configured as a non-rotationally symmetrical design of one of said bearing parts.

8. The electrical machine as defined in claim 1, wherein said rotation lock is configured as a notch structure.

9. The electrical machine as defined in claim 1, wherein said rotation lock is configured as a segment structure.

10. The electrical machine as defined in claim 1, wherein the electrical machine comprising said housing, said rotor, and said rotor bearing is a motor.
